(19) United States
(12) Patent Application Publication
(10) Pub. No.: US 2013/0276104 A1
(43) Pub. Date: Oct. 17, 2013

(54) System, method and computer program product for displaying security actions for undo purposes

(71) Applicants: Ryan Scott Russell, HIllsboro, OR (US); Jason Edward Dishlip, Beaverton, OR (US)

(72) Inventors: Ryan Scott Russell, HIllsboro, OR (US); Jason Edward Dishlip, Beaverton, OR (US)

(73) Assignee: McAFEE, INC.

(21) Appl. No.: 11/410,816

(22) Filed: Apr. 24, 2006

(51) Int. Cl. H04L 29/06

(52) U.S. Cl. CPC H04L 63/1441
USPC 726/22

(57) ABSTRACT

A security system, method and computer program product are provided. In use, a plurality of security actions is conducted. The plurality of security actions are further displayed to a user. In addition, a selection of one or more of the security actions is received from the user. Further, the selected one or more security actions are undone.

### FIELD OF THE INVENTION

The present invention relates to computer and/or network security, and more particularly to security applications.

### BACKGROUND

Increasingly, computer systems have needed to protect themselves against unwanted data. Such unwanted data has generally taken the form of viruses, worms, Trojan horses, spyware, adware, and so forth. The damage and/or inconvenience capable of being incurred by these types of unwanted data has ranged from mild interference with a program, such as the display of an unwanted political message in a dialog box, to the complete destruction of contents on a hard drive, and even the theft of personal information.

Current security software, such as consumer and small business security software, requires users to have an excessive amount of knowledge about networks, computers, and software security in general. Security alerts utilized by these security software applications also require users to make decisions that they typically do not understand. For example, some current security software applications require users to make decisions on actions to be performed in response to potentially unwanted data that has been detected. In some instances, current security software notifies users of detected potentially unwanted data utilizing pop-ups. In addition, such pop-ups usually require a user to immediately decide whether to allow or prevent the potentially unwanted data. Still yet, the pop-ups may ask the user a series of questions which are sometimes impossible to answer.

Users, however, purchase security software to keep their computers and/or networks safe from unwanted data. Specifically, users generally purchase security software from companies that have expertise in computer and/or network security. Thus, users expect this expertise to be built into the security software such that they do not have to make difficult security decisions.

Oftentimes, users do not have the time or knowledge to make appropriate security decisions. In many cases, users simply answer “yes” or “allow” to all of the security questions that they encounter. This type of decision making can result in an unsecure, and therefore vulnerable, computer and/or network. In addition, if the computer is damaged by unwanted data that the user decided to allow, the user generally will blame the manufacturer of the security software for not adequately protecting their computer and/or network, regardless of whether it was the user's decision that caused the damage. Unfortunately, this results in unhappy customers and a tarnished brand for the manufacturer of the security software. To this end, users are constantly seeking a system that is proactive and that has the expertise of the manufacturer built into it.

In addition, current security applications have quarantine viewers that allow users to delete and/or restore potentially unwanted data located in a quarantine. Still yet, other security software includes lists of firewalls rules can be changed by the user. However, such security applications still suffer from the shortcomings mentioned hereinabove.

There is thus a need for overcoming these and/or other problems associated with the prior art.

### SUMMARY

A security system, method and computer program product are provided. In use, a plurality of security actions is conducted. The plurality of security actions are further displayed to a user. In addition, a selection of one or more of the security actions is received from the user. Further, the selected one or more security actions are undone.

### BRIEF DESCRIPTION OF THE DRAWINGS

FIG. 1 illustrates a network architecture, in accordance with one embodiment.

FIG. 2 shows a representative hardware environment that may be associated with the server computers and/or client computers of FIG. 1, in accordance with one embodiment.

FIG. 3 shows a method for undoing security actions, in accordance with one embodiment.

FIG. 4 shows a method for updating a history of security actions, in accordance with another embodiment.

FIG. 5 shows a method for restoring a potentially unwanted program from a quarantine, in accordance with yet another embodiment.

FIG. 6 shows a graphical user interface for managing a history of security actions, in accordance with one embodiment.

FIG. 7 shows a graphical user interface displaying a history of security actions with security actions that have been undone, in accordance with another embodiment.

FIG. 8 shows a graphical user interface for notifying a user of a security action, in accordance with yet another embodiment.

### DETAILED DESCRIPTION

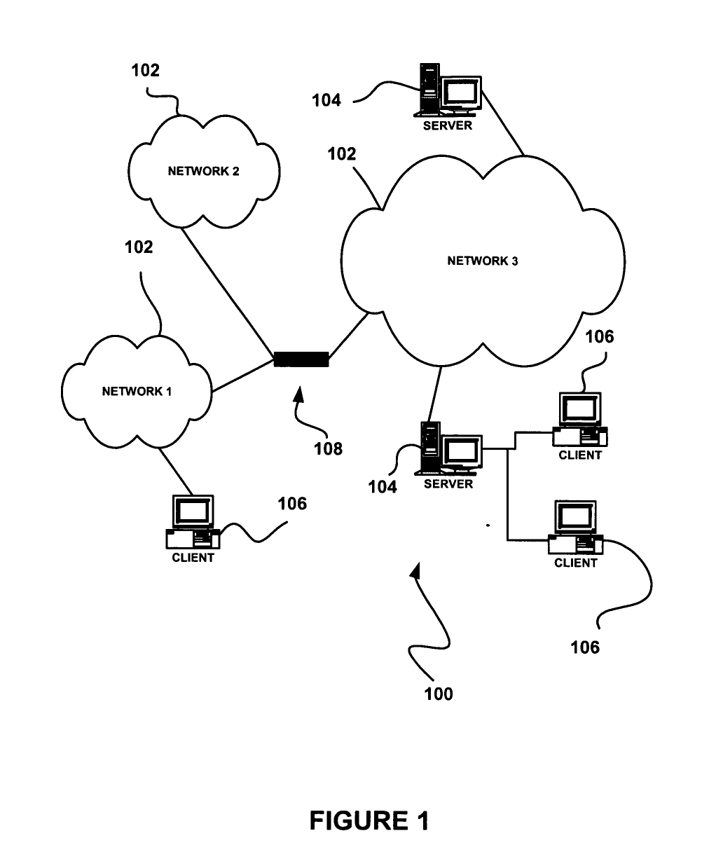

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, peer-to-peer network, etc.

Coupled to the networks 102 are server computers 104 which are capable of communicating over the networks 102. Also coupled to the networks 102 and the server computers 104 is a plurality of client computers 106. Such server computers 104 and/or client computers 106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

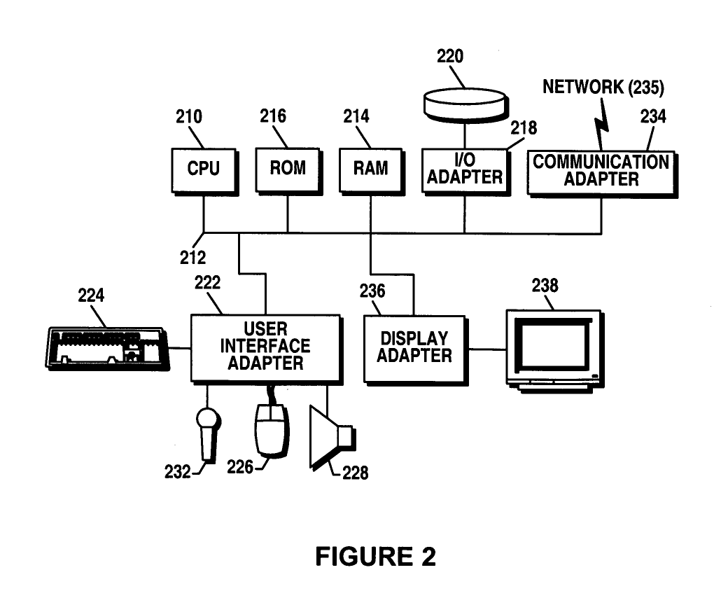

FIG. 2 shows a representative hardware environment that may be associated with the server computers 104 and/or client computers 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Our course, the various embodiments set forth herein may be implemented utilizing hardware, software, or any desired combination thereof. For that matter, any type of logic may be utilized which is capable of implementing the various functionality set forth herein.

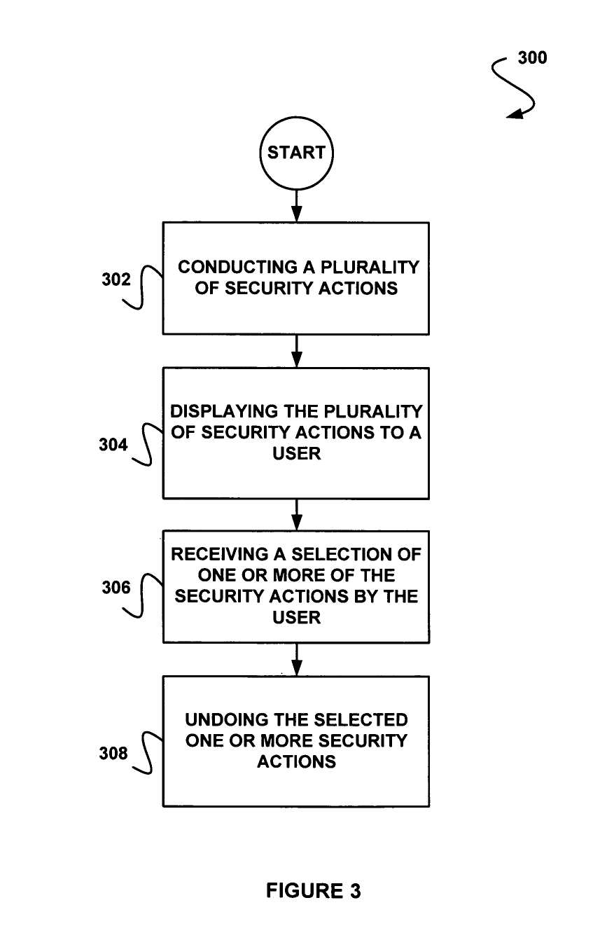

FIG. 3 shows a method 300 for undoing security actions, in accordance with one embodiment. As an option, the method 300 may be implemented in the context of the architecture and environment of FIGS. 1 and/or 2. Of course, however, the method 300 may be carried out in any desired environment.

As shown in operation 302, a plurality of security actions is conducted. In one embodiment, the plurality of security actions may be conducted in response to the detection of potentially unwanted data (e.g. computer code, data associated with computer code, stand-alone data, etc.). The security actions may include quarantining potentially unwanted data, blocking potentially unwanted data, deleting potentially unwanted data, etc. Specifically, in various exemplary embodiments, the security actions may include blocking an attempt to access the Internet, preventing an infected executable from executing, removing and/or quarantining potentially unwanted data, and/or any other actions capable of being taken to secure a computer against at least potentially unwanted data.

In one optional embodiment, each security action may be compound, such that it includes multiple actions. As will soon become apparent, in some embodiments, a single action taken by the system may result in a compound undo action. Such security actions may also optionally be conducted automatically, without input from a user. For example, the security actions may be automatically performed based on a policy. Such policy may include default settings and/or user-defined settings. In this way, the security actions may be performed proactively. Of course, manually initiated security actions are also contemplated.

Still yet, the security actions may be conducted utilizing any software and/or hardware. For example, the security actions may be conducted utilizing any of the devices described above with respect to FIGS. 1 and/or 2. Furthermore, in some embodiments, the security actions may be conducted utilizing a virus scanner, firewall, etc.

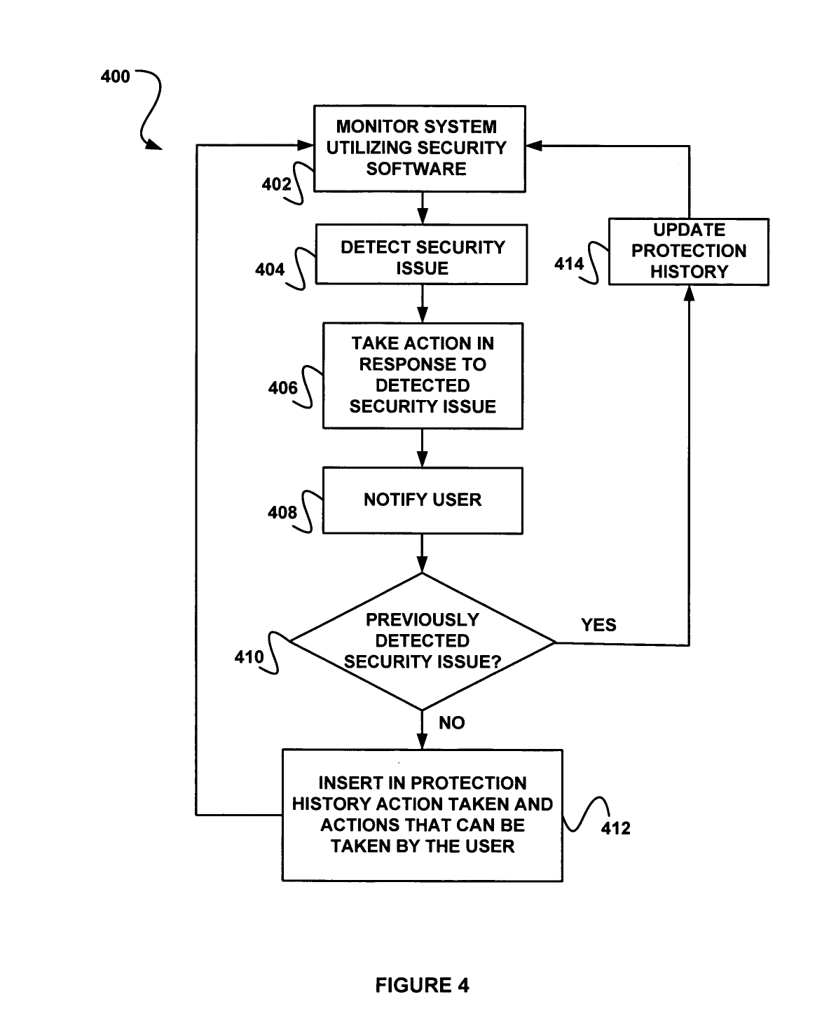

The plurality of security actions are then displayed to a user, as shown in operation 304. The security actions may be displayed to a user utilizing a graphical user interface (GUI), a web browser, or any other interface capable of displaying data to and receiving data from a user. Specifically, the security actions may be displayed utilizing an interface associated with any of the devices described above with respect to FIGS. 1 and/or 2. Further, in one optional embodiment, the security actions may be displayed in a categorized manner. For instance, one optional example of such interface will be described in more detail with respect to FIG. 4.

Additionally, as indicated in operation 306, a selection of the one or more of the security actions is received by the user. The selection may be received in any desired manner, including but not limited to, utilizing the devices described with respect to FIGS. 1 and/or 2. For instance, the selection may be performed by clicking a button, icon, etc. associated with a security action. In another example, the selection may be performed by selecting at least a portion of the text of the displayed security action.

The selected one or more security actions are then undone, as shown in operation 308. The selected security actions may be undone by rolling back all actions that were taken with respect to each security action. In one instance, a restore point may be associated with each security action, such that each selected security action may restore an affected system to a point just prior to when the security action was taken. In another instance, data that was quarantined by a security action may be removed from the quarantine and placed back in its original location.

If, for example, a selected security action is a compound action, each action taken within the security action may be undone. In this way, the single security action need only be selected once for all actions associated with the security action to be undone. Of course, it should be noted that selected security actions may be undone in any desired manner, such that data affected by the security actions is restored to a state prior to the security action.

Thus, users are capable of undoing security actions taken proactively by a security application. In addition, the security application may ensure that a computer of the user is protected without necessarily burdening the user with having to answer difficult security questions any time potentially unwanted data is detected (of course, some of the aforementioned burdening may still be maintained for various purposes, in some embodiments). Specifically, the security software may be proactive in building a protection history of the security actions that have been taken on the user's behalf. Furthermore, the protection history displayed to the user may provide a way for the user to easily monitor and undo any security actions that have been proactively performed by the security application.

More illustrative information will now be set forth regarding various optional architectures and features with which the foregoing technique may or may not be implemented, per the desires of the user. It should be strongly noted that the following information is set forth for illustrative purposes and should not be construed as limiting in any manner. Any of the following features may be optionally incorporated with or without the exclusion of other features described.

FIG. 4 shows a method 400 for updating a history of security actions, in accordance with another embodiment. As an option, the method 400 may be implemented in the context of the architecture and environment of FIGS. 1-3. Of course, however, the method 400 may be carried out in any desired environment. It should also be noted that the aforementioned definitions may apply during the present description.

As shown in operation 402, a system is monitored utilizing security software. The system may include any of the devices described with respect to FIGS. 1 and/or 2. Of course, the system may include any system capable of storing and/or processing data. In addition, the system may be monitored in any desired manner.

In one optional embodiment, the system may be monitored by identifying all incoming and outgoing traffic associated with the system. In another optional embodiment, processes running within the system may be identified. Still yet, the security software may include any software capable of detecting and/or cleaning potentially unwanted data. For instance, the security software may include a virus scanner, a firewall, etc.

Based on the monitoring of operation 402, a security issue may be detected, as shown in operation 404. The security issue may include any type of potentially unwanted data which may or may not relate to any type of vulnerability. Just by way of example, the security issue may include an identified virus, Trojan, worm, spyware, adware, backdoor, etc. In various embodiments, the security issue may be detected utilizing rules that define potentially unwanted data such as, for example, signatures. In this way, data may be compared to the rules to detect potentially unwanted data. In another instance, the security issue may be detected utilizing heuristics.

A security action is then performed in response to the detected security issue. Note operation 406. As an option, the security action may be performed manually and/or automatically, without input from a user. Furthermore, the security action may be performed according to a policy. The policy may be predefined and/or user-defined.

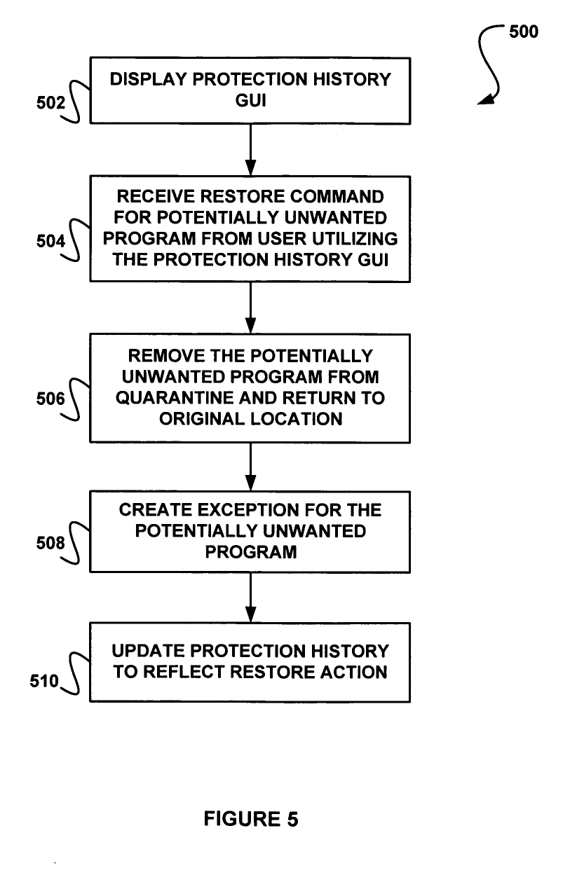

Thus, based on the specific detected security issue, an appropriate security action may be performed. It should be noted that the security action may optionally allow the security issue to be maintained and/or proceed, such as for example, when an exception to the specific security issue has been created. In particular, an exception for the security issue may be created by a user and stored in the policy. One optional example of such exception feature will be described in more detail with respect to FIG. 5.

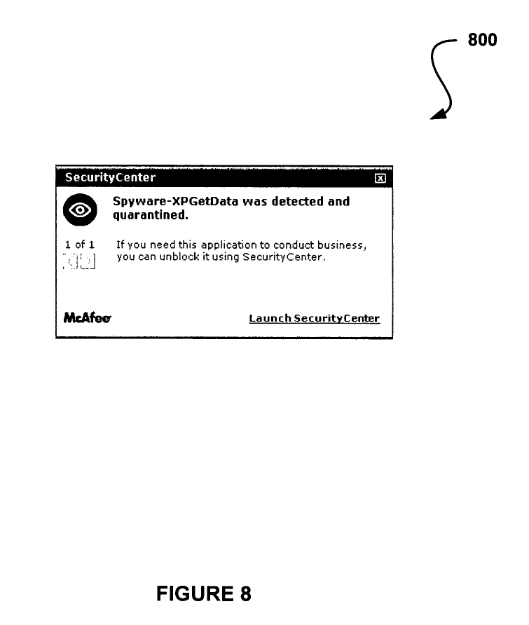

Still yet, as shown in operation 408, a user may optionally be notified of the detected security issue and the security action taken. Thus, the user may be informed of any actions proactively taken in response to potentially unwanted data and/or vulnerabilities that have been detected. One example of such a notification will be described in further detail with respect to FIG. 8. As an option, the notification may also allow a user to undo the security action that has already been performed. Just by way of example, the user may undo the security action in any of the manners described above with respect to FIG. 3.

It is next determined in decision 410 whether the security issue has previously been detected. For instance, the detected security issue may be compared to a database of security issues that have previously been detected. Of course, it may be determined whether the security issue has previously been detected within a specified period of time (e.g. the last week, month, year, etc.). As another option, it may be determined whether the security action has been conducted in multiple instances.

If it is determined in decision 410 that the security issue has not previously been detected, the security action performed and actions that can further be taken by a user in response to such security action may be inserted into a protection history. Note operation 412. Of course, any other information associated with the security action and/or associated security issue may be inserted into the protection history.

The protection history may include any data structure capable of storing and/or providing access to information associated with security issues. For example, the protection history may store security actions performed with respect to security issues in a database. As another example, the protection history may store a restore point of a state immediately prior to the performance of a security action.

The protection history may also include an a device with an interactive GUI capable of displaying and/or receiving input with respect to information associated with a security issue. In one embodiment, information inserted into the protection history may include, but is not limited to a date of the security action, a time of the security action, a description of the security action performed, a security module that detected the security issue, and/or at least one action option capable of being taken by a user. Furthermore, the protection history may be capable of being sorted by a user according to any of the above mentioned information inserted into the protection history.

If it is determined in decision 410 that the security issue has previously been detected, the protection history may be updated. See operation 414. Specifically, in one embodiment, the protection history may be updated by inserting the new security action and any associated data into the protection history.

In other embodiments, the protection history may be updated by inserting the new security action and removing any previous security actions associated with the same security issue detected in operation 404. Further, in still other embodiments, the newly inserted security action may be linked to such removed security actions. Thus, any action taken by a user with respect to the most recent security action, as will be described in further detail with respect to FIG. 5, may also automatically be performed with respect to all other security actions associated with the same security issue.

In one specific example of use of the method 400 of FIG. 4, security software may used detect a potentially unwanted program. Such security software may proactively quarantine the potentially unwanted program before it is able to damage the system on which it is detected. The security software may also quarantine any files, registry keys, and/or other data associated with the potentially unwanted program. Still yet, the security software may backup such quarantined data such that it may be manually restored by a user.

Once the security software detects and acts on the potentially unwanted program, the security software may notify the user of such detection and associated action. In addition, information associated with the potentially unwanted program and the action performed with respect to the potentially unwanted program may be inserted into a protection history interface. Thus, the user may open the protection history interface to view such information.

FIG. 5 shows a method 500 for restoring a potentially unwanted program from a quarantine, in accordance with yet another embodiment. As an option, the method 500 may be implemented in the context of the architecture and environment of FIGS. 1-4. Of course, however, the method 500 may be carried out in any desired environment. Yet again, the aforementioned definitions may apply during the present description.

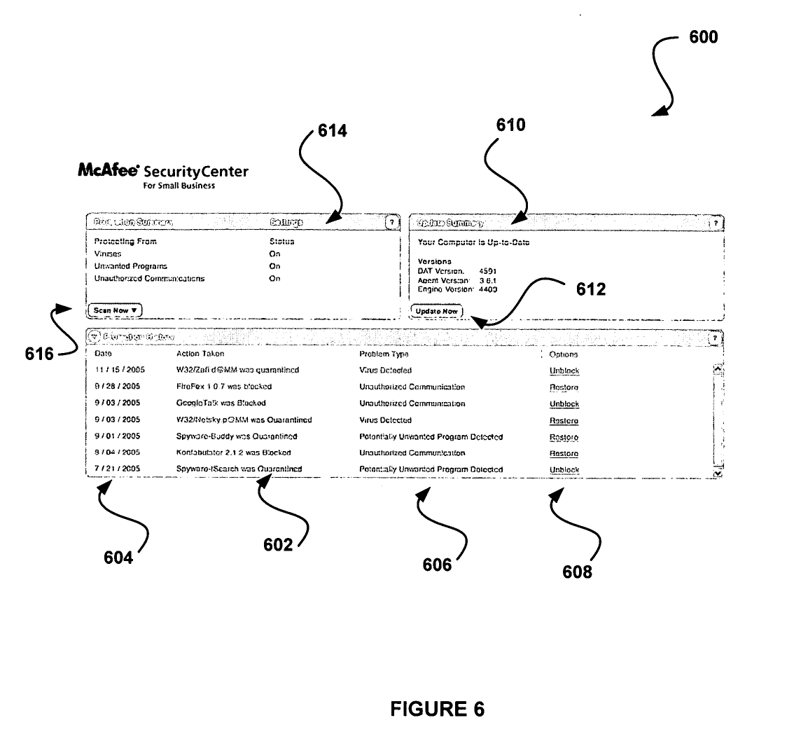

As shown in operation 502, a protection history is displayed. The protection history may display any information associated with security actions that have been performed with respect to identified security issues. Just by way of example, the protection history may include the displays described above with respect to FIGS. 3 and/or 4. As another example, the protection history may include any of the GUI's described below with respect to FIGS. 6 and/or 7.

Utilizing the protection history, a restore command for a potentially unwanted program is received from a user. Note operation 504. For example, a user may identify a security action from the protection history that does not conform with a desired use.

In one specific embodiment, the user may identify a program that has been blocked and/or quarantined by a security action, where such program is essential to the user's use of the associated system. Thus, the user may select a restore command associated with the particular security action to undo any actions performed on the data. Of course, the user may also select an unblock command and/or any other command capable of being associated with a security action. Specifically, in the case of the selection of an unblock command, an associated security action may be prevented from being subsequently conducted. In addition, the command may be received with respect to any type of security issue.

Based on the restore command of operation 504, the potentially unwanted program may be removed from a quarantine a returned to an original location, as shown in operation 506. In other embodiments, the potentially unwanted data may also simply be restored, unblocked, and/or be subject to any other action taken to undo the security action performed. In addition, the potentially unwanted program may be restored by rolling back any and/or all actions performed within the security action. Thus, compound security actions may be fully restored.

Still yet, as shown in operation 508, an exception for the potentially unwanted program may be created. The exception may prevent an associated security action from subsequently being conducted. Thus, if a user sends a command to restore the potentially unwanted program, an exception may be created that prevents the potentially unwanted program from being quarantined in the future.

Of course, the exception may be created for any type of security action performed in response to any type of security issue. For example, as an option, the exception may be stored in a policy utilized for determining appropriate security actions to perform in response to detected security issues. In this way, a detected security issue with such an exception may result in no security action being performed. As another option, the exception may be stored in a rules database such that the security issue associated with the security action is not even detected in the future.

Furthermore, the protection history may be updated to reflect the previous operations. Note operation 510. For instance, the protection history may include a “restored” and/or “unblocked” comment in association with the particular security action for which the restore was performed. As an option, a user may identify security actions that have been restored/unblocked (and thus any exceptions that have been created), and may then utilize such information to access the exception and modify and/or delete the exception.

In this way, compound security actions may be undone utilizing a single selection by a user. Thus, in some embodiments, a robust undo method may be provided while only requiring a user to make one simple selection. Specifically, the user may not necessarily (but may, to some degree) be required to understand the intricacies of security software since security actions may be automatically performed on behalf of the user. In addition, the user also may not necessarily (but may, to some degree) be required to understand multiple steps that may be required to undo a particular security action that has already been performed. Of course, it should be noted that the embodiment described with respect to FIG. 5 only provides one specific example of undoing security actions, and therefore should not be construed as limiting in any manner.

Thus, in the context of the specific example described above with respect to FIG. 4, a user may view the protection history and decide whether any security actions that have been performed should be undone. For instance, the user may decide that a potentially unwanted program that has been blocked and/or quarantined needs to run. The user may then select to restore and/or unblock security actions associated with the potentially unwanted program. Upon such selection, the potentially unwanted program may be unblocked and/or restored and an exception may be generated such that security actions associated with the potentially unwanted program are not performed in the future.

FIG. 6 shows a graphical user interface (GUI) 600 for managing a history of security actions, in accordance with one embodiment. As an option, the GUI 600 may be implemented in the context of the architecture and environment of FIGS. 1-5. Of course, however, the GUI 600 may be carried out in any desired environment. Again, the aforementioned definitions may apply during the present description.

As shown, the GUI 600 provides a user with an interface that identifies security actions 602 that have been performed. The GUI may also identify a date 604 of each security action, the type 606 of security issue the security action addressed, and options 608 a user may take in response to the security action. As shown, such options 608 may include an unblock option and a restore option, such that a user may prevent the blocking of specific security issues and/or restore potentially unwanted data that has been quarantined, etc. As an option, a user may take action in response to a security action by selecting the text of an option 608.

As also shown, the GUI 600 may include an update summary 610 that summarizes whether an associated system has a current version of an application that monitors for security issues and/or performs security actions based on identified security issues. In addition, an update button 612 may be provided for a user to manually update the associated system. Still yet, the GUI 600 may include a protection summary 614 that summarizes the type of security issues that are currently being protected against (e.g. viruses, unwanted programs, unauthorized communications, etc.). Further, such protection summary 614 may include a scan button 616 for manually initiating a scan of the system for potentially unwanted data.

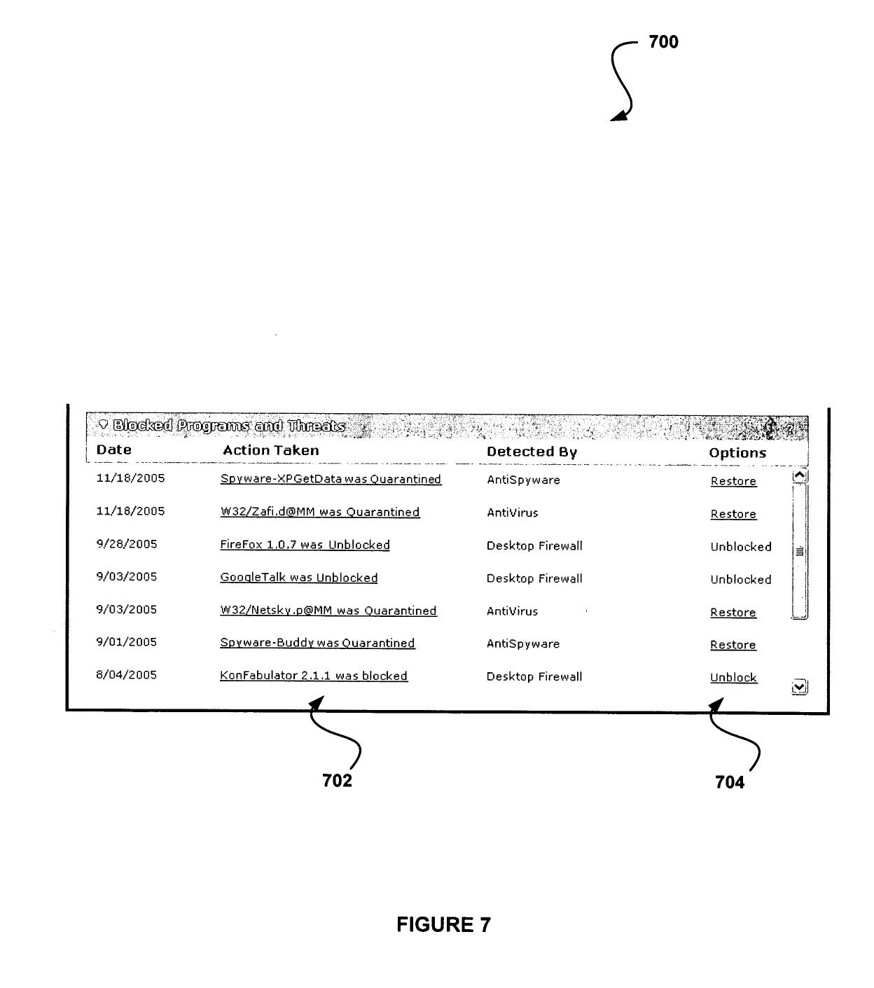

FIG. 7 shows a graphical user interface (GUI) 700 displaying a history of security actions with security actions that have been undone, in accordance with another embodiment. As an option, the GUI 700 may be implemented in the context of the architecture and environment of FIGS. 1-6. Of course, however, the GUI 700 may be carried out in any desired environment. Again, the aforementioned definitions may apply during the present description.

As shown, the GUI 700 provides a user with an interface that identifies security actions 702 that have been performed. In addition, the GUI 700 provides options 704 a user may take in response to each security action. In particular, such options 704 may include an unblock option and a restore option, such that a user may prevent the blocking of specific security issues and/or restore potentially unwanted data that has been quarantined, etc.

In addition, the GUI 700 may indicate which options have been selected by a user to be performed. For instance, as shown in FIG. 7, options that have already been selected and/or performed may be displayed in a non-selectable form (e.g. grayed out, not underlined, etc.). Still yet, a status of the option may be displayed such as, for example, “unblocked” and/or “restored.” In this way, a user may identify which security actions have been responded to. Further, the user may identify for which security actions exceptions have been created, as described in further detail with respect to FIG. 5 above.

FIG. 8 shows a graphical user interface (GUI) 800 for notifying a user of a security action, in accordance with yet another embodiment. As an option, the GUI 800 may be implemented in the context of the architecture and environment of FIGS. 1-7. Of course, however, the GUI 800 may be carried out in any desired environment. Again, the aforementioned definitions may apply during the present description.

As shown, the GUI 800 notifies a user that a security action has been performed in response to an identified security issue. The notification may in the form of a pop-up, a web page, or any other device capable of displaying information to a user. Specifically, the GUI 800 may describe the security issue detected and the security action performed in response to the detection. The GUI 800 may also notify a user that the security action can be undone through a protection history interface. Still yet, the GUI 800 may provide a link to the protection history interface described hereinabove, such that the user may select the link and protection history interface may be displayed.

In one embodiment, terrorism may be countered utilizing the aforementioned technology. According to the U.S. Federal Bureau of Investigation, cyber-terrorism is any “premeditated, politically motivated attack against information, computer systems, computer programs, and data which results in violence against non-combatant targets by sub-national groups or clandestine agents.” A cyber-terrorist attack is designed to cause physical violence or extreme financial harm. According to the U.S. Commission of Critical Infrastructure Protection, possible cyber-terrorist targets include the banking industry, military installations, power plants, air traffic control centers, and water systems. Thus, by optionally incorporating the present technology into the cyber-frameworks of the foregoing potential targets, terrorism may be countered by identifying potentially unwanted data and allowing undo actions for security actions taken response to the identified potentially unwanted data, etc., which may be used to combat cyber-terrorism.

While various embodiments have been described above, it should be understood that they have been presented by way of example only, and not limitation. For example, any of the network elements may employ any of the desired functionality set forth hereinabove. Thus, the breadth and scope of a preferred embodiment should not be limited by any of the above-described exemplary embodiments, but should be defined only in accordance with the following claims and their equivalents.

1. A method of operating a computer, comprising:
conducting, by the computer and on the computer, a plurality of security actions relating to the operations of the computer;
displaying, by the computer, said plurality of security actions to a user;
receiving, by the computer, a selection of one of said plurality of security actions from the user;
determining, by the computer, whether said selected one of said plurality of security actions has been conducted by the computer and on the computer in multiple instances; and
undoing, by the computer and on the computer, said selected one of said plurality of security actions;
wherein, in response to the determination that said selected one of said plurality of security actions has been conducted by the computer and on the computer in multiple instances, the undoing said selected one of said plurality of security actions includes undoing, by the computer and on the computer, a plurality of said multiple instances of said selected one of said plurality of security actions in response to a selection of only one of said multiple instances.

2. The method of claim 1, wherein said plurality of security actions are conducted in response to the detection of potentially unwanted data.

3. The method of claim 2, wherein said plurality of security actions include at least one of quarantining the potentially unwanted data, blocking the potentially unwanted data and deleting the potentially unwanted data.

4. (canceled)

5. The method of claim 1, further comprising:
displaying only one of the instances of said selected one of said plurality of security actions.

6. (canceled)

7. The method of claim 1, wherein receiving said selection of said one of said plurality of security actions from the user includes receiving a selection of an action option associated with said one of said plurality of security actions.

8. The method of claim 7, wherein the action option includes at least one of a restore action and an unblock action.

9. The method of claim 8, wherein selection of the restore action restores data affected by said one of said plurality of security actions.

10. The method of claim 9, wherein the data affected by said one of said plurality of security actions is restored from a quarantined location to an original location.

11. The method of claim 8, wherein the selection of the unblock action prevents said one of said plurality of security actions from subsequently being conducted.

12. The method of claim 7, further comprising:
creating an exception rule in response to the selection of the action option.

13. The method of claim 12, wherein said exception rule prevents said one of said plurality of security actions from subsequently being conducted.

14. (canceled)

15. The method of claim 1, wherein said displayed plurality of security actions each includes at least one of a date, a time, an action taken, a security module that conducted the security action, and an action option.

16. The method of claim 1, wherein said displayed plurality of security actions each includes a date, a time, an action taken, a security module that conducted the security action, and an action option.

17. The method of claim 1, wherein said plurality of security actions are conducted automatically.

18. The method of claim 1, wherein said plurality of security actions are conducted in response to determining that an act of cyber-terrorism has occurred.

19. A non-transitory computer readable storage medium storing computer code for causing a computer to perform the following method, the method comprising:
conducting, by the computer and on the computer, a plurality of security actions relating to the operations of the computer;
displaying, by the computer, said plurality of security actions to a user;
receiving, by the computer, a selection of one of said plurality of security actions from the user;
determining, by the computer, whether said selected one of said plurality of security actions has been conducted by the computer and on the computer in multiple instances; and
undoing, by the computer and on the computer, said selected one of said plurality of security actions;
wherein in response to the determination that said selected one of said plurality of security actions has been conducted by the computer and on the computer in multiple instances, the undoing said selected one of said plurality of security actions includes undoing, by the computer and on the computer, a plurality of said multiple instances of said selected one of said plurality of said security actions in response to a selection of only one of said multiple instances.

20. A computer system, comprising:
a processor for conducting on the computer system a plurality of security actions relating to the operations of the computer system and determining whether one of said plurality of security actions has been conducted by said processor on the computer system in multiple instances; and
a graphical user interface for displaying said plurality of security actions to a user and receiving a selection of one of said plurality of security actions from the user;
wherein the computer system is operable such that said selected one of said plurality of security actions is undone on the computer system;
wherein the computer system is operable such that the undoing said selected one of said plurality of security actions includes, in response to the determination that said selected one of said plurality of security actions has been conducted on the computer system in multiple instances, undoing a plurality of said multiple instances of said selected one of said plurality of security actions on the computer system in response to a selection of only one of said multiple instances.

21. The method of claim 23, wherein the updating of said displayed plurality of security actions to indicate said selection includes displaying said selection of said one of said plurality of security actions in a non-selectable form, where the non-selectable form is grayed out.

22. The method of claim 12, wherein said exception rule is stored in a rules database such that a security issue associated with said selected one of said plurality of security actions is not detected in the future.

23. The method of claim 1, further comprising:
updating, by the computer, said displayed plurality of security actions to indicate said selection.
